(19) United States
(12) Patent Application Publication
(10) Pub. No.: US 2002/0070318 A1
(43) Pub. Date: Jun. 13, 2002

(54) Work surface arm support

(76) Inventor: Kenneth L. Dunahee, City of Maryville, IL (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 09/735,773

(22) Filed: Dec. 13, 2000

Related U.S. Application Data
(60) Provisional application No. 60/170,624, filed on Dec. 14, 1999.

(51) Int. Cl. B68G 5/00

(52) U.S. Cl. 248/118

(57) ABSTRACT

Apparatus for suspending a user's hands and wrists above a work piece, such as a typewriter or computer keyboard to prevent repetitive stress injury. The apparatus has a frame of sufficient height and width so as to allow the work piece to be positioned below the frame. A pair of adjustable slings are suspended from the frame. Each sling includes a loop on the bottom ends to secure the user's forearms and suspend the user's arms and hands above the work piece.

### CROSS REFERENCE TO RELATED APPLICATIONS

This application claims priority to provisional application Serial No. 60/170,624, filed Dec. 14, 1999.

### BACKGROUND THE INVENTION

This invention relates generally to supports for a user's hands engaged in repetitive motion work, such as typing on a computer keyboard and, more specifically, to a frame and suspended sling apparatus used to support the user's forearms and wrist and relieve pressure on the user's hands and wrists.

Repetitive motion or stress injuries are well documented. For example, it is well recognized that repetitive hand movements and positioning, such as occurs when a worker types on a computer or typewriter keyboard for extended periods of time, can cause injury to the worker's hands and wrist. Most notably, many such workers are afflicted with carpal tunnel syndrome. Carpal tunnel syndrome is characterized by tingling, numbness and pain in the hand which can be disabling and require surgical intervention. Such painful conditions, as will as surgery, can result in job absence, loss in productivity, and costs.

Various prior art methods of alleviating or preventing such repetitive motion disorders caused by extended work at a keyboard. For examples, workers sometimes use wrist splints to support and partially immobilize the wrists. Ergonomically designed keyboards have been touted as a preventative measure. Often the keyboard itself can be equipped with a riser or pad along the front edge on which the typist can rest his or her forearms or wrists to alleviate pressure.

For the most part, prior art attempts to prevent the repetitive motion injuries have been unsatisfactory. For example, the use of risers or pads, or even redesigned keyboards, still require the typist to place pressure on the forearm and wrist as it rests on the riser or pad. Furthermore, it can be awkward to type with speed and accuracy while resting the wrists and forearms on a pad or riser.

It would be advantageous, therefore, to have an apparatus that nearly completely alleviates pressure on the wrists of a typist working at a keyboard.

### SUMMARY OF THE INVENTION

It is among the several objects of the present invention to provide an apparatus, which can be used by a typist at a keyboard to nearly completely alleviate any pressure on the typist's wrists.

Another object of the present invention is to provide an apparatus which allows the typist hands to be suspended above the keyboard so as to prevent pressure.

Yet another object of the present invention is to provide such an apparatus, which is simple and economical to construct, easy to use, and well suited for its intended purposes.

In accordance with the invention, generally stated, an apparatus for suspending a user's hands and wrists above a work piece, such as a typewriter or computer keyboard is provided. The apparatus comprises a frame having two vertical end members and a cross member connecting the upper ends of the end members. The frame can be mounted to the front edge of the work surface support surface, most commonly a desk, with C-clamps or other appropriate means. The frame is of sufficient height and width so as to allow the keyboard, for example, to be positioned on the desktop between the vertical members.

The apparatus includes a pair of adjustable slings suspended from the cross member. The slings can consist of a pair of straps with a loop at the upper end for sliding engagement of the cross member, and loop on the bottom end for the introduction of the typist's forearms. Either of the loops can be formed by looping the end of the strap back onto itself and securing the end to the strap with Velcro®. The Velcro® strips on the strap are elongated and allow the loop to be adjusted so as to vary the length of the strap so that the length of the sling can be custom fitted to the typist.

### BRIEF DESCRIPTION OF THE DRAWINGS

FIG. 1 is a perspective view of the arm support apparatus of the present invention;

FIG. 2 is a perspective view of the arm support apparatus of the present invention mounted to a desk and in use to illustrate environment;

FIG. 3 is a perspective view of another embodiment of the arm support apparatus having floor bases and frame extensions; and

### DETAILED DESCRIPTION OF THE INVENTION

The arm support apparatus of the present invention is indicated generally by reference numeral 10 in the drawings. Apparatus 10 includes a frame 12 and a pair of suspension devices or arm supports, 14 and 16 suspended from the frame. As best seen in FIG. 2, apparatus 10 is designed to support the arms A of a typist T working at a keyboard K resting on a desk D. Although the apparatus 10 is illustrated in use with a desk and keyboard, it will be appreciated by those skilled in the art that apparatus 10 can be used by any worker engaged in repetitive manual activity with the hands. For example, an assembly worker engaged in assembly pieces at a workbench or like activity who desires free-floating support of the wrists and forearms.

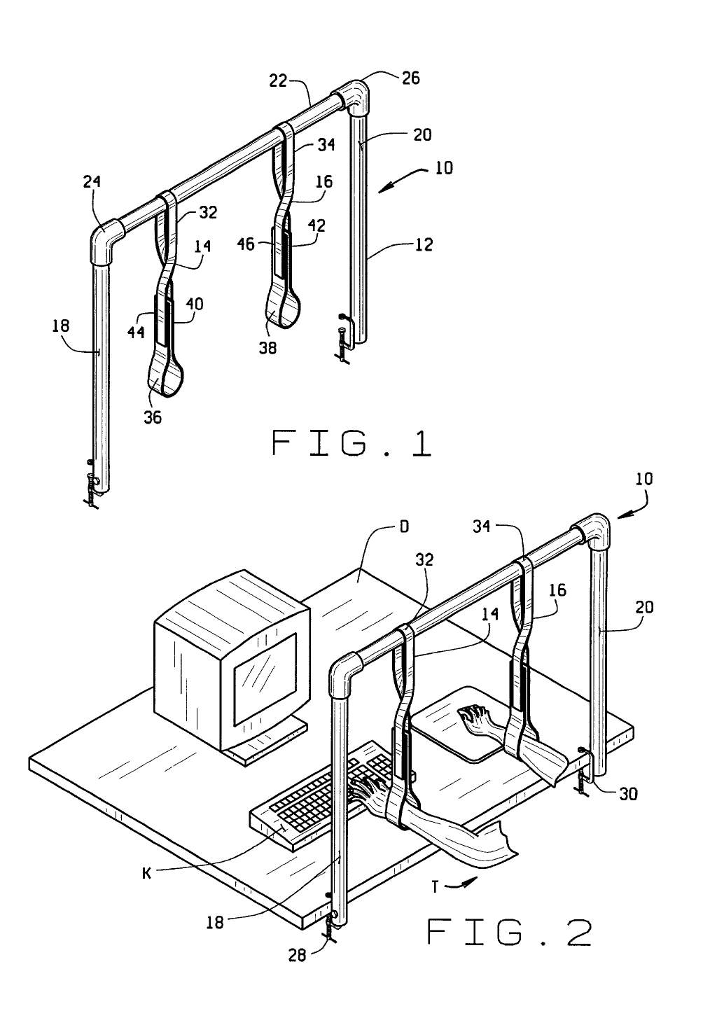

As best seen in FIGS. 1 and 2 the frame 12 includes a pair of opposed vertical members, 18 and 20 and a horizontal top or cross member 22 extending between the upper ends of the vertical members 18 and 20. It will be appreciated that the frame 12 can be constructed from one integral piece of PVC pipe, aluminum or any other appropriate, strong durable and light weight material which can be bent, connected or shaped into the appropriate configuration. The illustrated embodiment, however, is constructed of separate sections, which form the vertical members and cross member and are connected with elbows 24 and 26.

The length of the vertical members 18 and 20 and horizontal cross member 22 can be any desired dimension. As shown in FIG. 2, however, the dimensions should be such so as to allow for clearance for the appropriate positioning of the work piece, the keyboard for example, and head clearance for the user U. In one preferred embodiment, the vertical members 18 and 20 are twenty-eight inches long and the cross member 22 is thirty inches long.

As shown in FIGS. 1 and 2, each bottom end of the vertical members 18 and 20 includes attachment hardware 28 and 30, respectively. The hardware 28 and 30 as illustrated are C-clamps which can be attached appropriately to the edge of the work surface such as desk D shown in FIG. 2. The clamps 28 and 30 are removably attached to the vertical elements so that they can be removed to allow the vertical elements to slide into extensions, as will be discussed below. It will be appreciated that although the vertical members are shown employing C-clamps, any appropriate attachment hardware can be used, such as L-brackets or the like.

The arm supports 14 and 16, which function as suspension devices, are virtually identical, as now will be described. The arm supports 14 and 16 are comprised of straps 32 and 34, respectively, which terminate at one end with slings 36 and 38, respectively. The straps are generally flat, elongated and flexible. Slings 36 and 38 generally are wider than the straps so as to afford greater comfort to the user when the user's arms are cradled in the slings. In the illustrated embodiment the straps and slings are constructed from a soft fabric, such as cotton or canvas. It will be appreciated, however, that the straps could have round cross sections, like cord or rope, and be constructed from other appropriate material. Likewise the slings could be fabricated from other material, such as soft leather, or leather with a padded inner circumference, or the like, as long as they are of sufficient flexibility and width to afford comfort to the user.

One end arm supports 14 and 16 includes an elongated strips of loop or hook fastener material 40 and 42 such as Velcro®. The opposite ends of the straps 32 and 34 on or adjacent the slings, include complementary strips of loop and hook fastener 44 and 46 or Velcro®. The straps can then be looped over the horizontal cross member 22 and the opposed strips of Velcro® secured to hold the straps. It will be appreciated that because the opposed strips of Velcro® are elongated, the distance of the slings from the work surface can be adjusted for individual users. It also will be appreciated that other attachment devices for attaching the straps to the cross member, such as snaps, buttons or buckles, may be employed without departing from the scope of the invention. It is advantageous, however that the method of attachment allow the straps to slide in horizontally along the cross member so that the distance between the straps can be adjusted for individual users. Moreover, other methods of adjusting the length of the straps may be employed without departing from the scope of the invention.

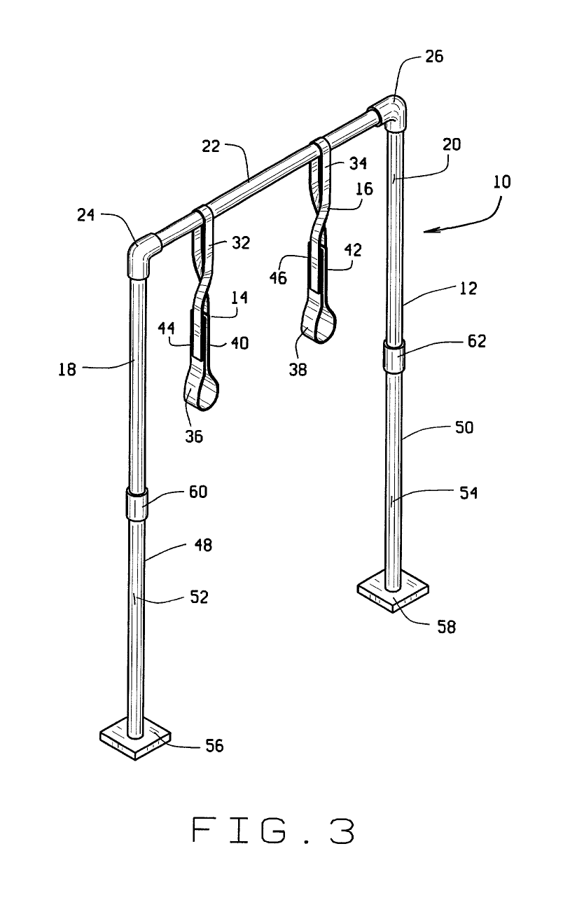

As shown in FIG. 3, the apparatus 10 can be adapted to rest on the floor instead of attachment to the work surface. Extensions 48 and 50 are comprised of vertical members 52 and 54 respectively. The bottom ends of the vertical members 52 and 54 can be secured in a base 56 and 58. The bases 56 and 58 are designed to rest on the floor and are of sufficient dimension and weight to resist tipping. The upper ends of the vertical members 52 and 54 include sleeves 60 and 62 respectively. It will be appreciated that the sleeves 60 and 62 are slightly oversized with respect to the vertical members 18 and 20. The attachment hardware 28 and 30 is removed from the ends of vertical members 18 and 20 and the ends then can be inserted into sleeves 60 and 62 to be secured with a snug friction fit or a cotter pin or other appropriate methods.

In use, the apparatus is appropriately positioned relative to the work surface, as shown in FIG. 2. The typist T then adjusts, one at a time, the length of the straps so that the user's hands are position the appropriate distance from the keyboard to allow the hands and fingers to access the keys for typing, but allow the arms to free float above the keyboard, thereby eliminating pressure on the wrists and forearms.

It will be appreciated that various changes and modifications may be made in the apparatus without departing from the scope of the invention. Therefore, the foregoing description and accompanying drawings are illustrative and should not be construed in a limiting sense.

1. An apparatus to support of a user's arms above a work piece to prevent repetitive stress injury comprising:
A frame for positioning above the work piece positioned on a work surface; and
At least one flexible arm support suspended from said frame for supporting the arm of the user above the work surface, said arm support allowing the arm of the user to free float above the work piece thereby relieving resting pressure from the arm.

2. The apparatus of claim 1 wherein the frame includes mounting hardware for securing the frame to the work surface.

3. The apparatus of claim 1 wherein said am support further comprises a strap having a sling at one end.

4. The apparatus of claim 3 further comprising at least two arm supports.

5. The apparatus of claim 1 wherein the frame includes a stand for resting the frame on a floor.

6. The apparatus of claim 1 wherein the arm support further includes an attachment device to attach the arm support to the frame.

7. The apparatus of claim 6 wherein the attachment device is a loop and hook fastener.

8. The apparatus of claim 2 wherein the hardware further comprises c-clamps.

9. The apparatus of claim 1 wherein the arm support is slidably attached to the frame.

10. An apparatus to support of a user's arms above a work piece positioned on a work surface to prevent repetitive stress injury to the user's arms, hands, or wrists comprising:
A frame positioned above the work area, said frame having a first upright member with an upper end and a lower end to support the frame above the work area, a second upright member with an upper end and a lower end to support the frame above the work area, and a horizontal frame member between the respective upper ends of the first and second upright members;
A first flexible suspension means having a first and second end attached to the horizontal frame member, the second end disposed to accommodate an arm of the user;
A second flexible suspension means having a first and second end attached to the horizontal frame member, the second end disposed to accommodate the other arm of the user, said first and second suspension means allowing the arms of the user to be suspended from the horizontal member of the frame and to free float above the work piece thereby relieving pressure from the arms.

11. The apparatus of claim 10 wherein the first and second suspension means each include an attachment device for attaching the suspension means to the horizontal frame member.

12. The apparatus of claim 11 wherein the first suspension means and the second suspension means are attached to the vertical member of the frame with loop and hook attachment device.

13. The apparatus of claim 10 wherein the first and second suspension means are slidably attached to the horizontal frame member.

14. The apparatus of claim 10 further including a floor mounted stand operably connected to the first and second vertical frame members.

15. An apparatus to support a user's arms above a work piece positioned on a work surface to prevent repetitive stress injury to the user's arms, hands or wrists comprising:
A frame positioned above the work area, said frame having a first upright member with an upper end and a lower end disposed to support the frame above the work area, a spaced apart second upright member with an upper end and a lower end disposed to support the frame above the work area, and a horizontal frame member between the respective upper ends of the first and second upright members;
A first flexible suspension strap having a first and second end, said first suspension strap being suspended from the horizontal frame member;
A first sling at the second end of the first suspension strap disposed to accommodate an arm of the user;
A first attachment device on said first flexible suspension strap to secure the strap to the horizontal frame member;
A second suspension strap having a first and second end, said second suspension strap suspended from the horizontal frame member in a space apart relationship to the first suspension strap;
A second sling at the second end of the second suspension strap disposed to accommodate another arm of the user;
A second attachment device on said second flexible suspension strap to secure the strap to the horizontal frame member,
Wherein said first and second suspension straps allow the arms of the user to be suspended from the horizontal frame member so as to free float above the work piece and thereby relieving pressure from the arms and hands.

16. The apparatus of claim 15 wherein said frame further comprises a floor stand to support the frame on a floor.

17. The apparatus of claim 15 wherein said first and second attachment devices each further comprise one of a strip of a hook or a loop fastener on the first end of the strap and a strip of the opposite hook or loop fastener adjacent the sling.

18. The apparatus of claim 15 wherein the first and second suspension straps are slidably mounted on the horizontal frame member so that the distance between the respective straps can be changed.
